(19) United States
(12) Patent Application Publication
(10) Pub. No.: US 2009/0073094 A1
(43) Pub. Date: Mar. 19, 2009

(54) IMAGE DISPLAY DEVICE

(75) Inventors: Hajime Akimoto, Kokubunji (JP); Naruhiko Kasai, Yokohama (JP); Masato Ishii, Toshima (JP); Tohru Kohno, Kokubunji (JP); Mitsuhide Miyamoto, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/212,691

(22) Filed: Sep. 18, 2008

(30) Foreign Application Priority Data
Sep. 19, 2007 (JP) 2007-241719

(51) Int. Cl. G09G 3/30

(52) U.S. Cl. 345/77

(57) ABSTRACT

To detect reduction of luminous efficiency of respective light-emitting elements arranged in a matrix state while suppressing increase of costs.

Plural pixels each having a current-drive type light emitting element, plural signal lines inputting image voltage to respective pixels and a pixel selection circuit for selecting pixels into which the image voltage is written through the plural signal lines from the plural pixels are included, in which the pixel selection circuit has plural detection gate lines, in which each pixel has a drive transistor a first electrode of which is connected to a power source line and a second electrode of which is connected to one end of the light emitting element and a detection transistor a first electrode of which is connected to one end of the light emitting element and a second electrode of which is connected to a corresponding signal line in the signal lines, in which the other end of the light emitting element of each pixel is connected to a reference potential, in which a gate electrode of the detection transistor is connected to a corresponding detection gate line in the plural detection gate lines, and in which the detection transistor is turned on during a detection period.

### CLAIM OF PRIORITY

The present application claims priority from Japanese application serial No. 2007-241719, filed on Sep. 19, 2007, the content of which is hereby incorporated by reference into this application.

### BACKGROUND OF THE INVENTION

1. Field of the Invention

The present invention relates to an image display device, and particularly relates to an active-matrix organic electroluminescent display.

2. Background Art

An active matrix driving organic electroluminescent display (hereinafter, referred to as an organic EL display device) is expected as a next generation flat panel display.

In related art, as a drive circuit of the organic EL display device, a circuit of a three-transistor configuration is known, which includes a thin-film transistor for driving (hereinafter, referred to as an EL drive TFT) for supplying electric current to an organic electroluminescent element (hereinafter, referred to as an organic EL element), a storage capacitor which is connected to a gate electrode of the EL drive TFT and stores image voltage, a thin-film transistor for resetting (hereinafter, referred to as a reset switch) which is connected between the gate electrode and a drain electrode of the EL drive TFT and a thin-film transistor for lighting (hereinafter, referred to as a lighting switch) as disclosed in the following Patent Document 1.

The organic EL element has a configuration in which a light emitting layer which is a thin film including a fluorescent organic compound of red, green or blue is sandwiched between an anode electrode and a cathode electrode, generating excitons by injecting electrons and holes into the light emitting layer and recombining them to emit light by light discharge generated when excitons are deactivated.

As a related art document relating to the application of the invention, there is the following one.

Patent Document 1: JP-A-2003-122301

### SUMMARY OF THE INVENTION

The luminous efficiency of the organic EL element is reduced depending on light-emitting time (current-carrying time) or a light-emitting amount. In the organic EL element, life until a state that luminance is reduced by half due to the reduction of the luminous efficiency is short, therefore, it was difficult to continue using a display device over a long period of time.

In order to solve the problem, an EL display device is also known, in which a dummy pixel is provided at an area outside a display area and voltage between terminals applied between both terminals of an EL element of the dummy pixel is detected to figure out the reduction rate of the luminous efficiency and to compensate the reduction of luminance.

However, in the above EL display device, there was a problem that it was necessary to provide the dummy pixel at the area outside the display area for detecting the reduction of luminous efficiency, which became a factor of increasing costs. In addition, the organic EL display device in related art was not capable of detecting the reduction of luminous efficiency of respective organic EL elements arranged in a matrix state.

The invention has been made in order to solve the problems of the related art and an object thereof is to provide a technique capable of detecting the reduction of luminous efficiency of respective light-emitting elements arranged in a matrix state while suppressing the increase of costs in an image display device.

The above and other objects and novel features of the invention will become clear by the description of the specification and attached drawings.

Summaries of typical inventions in inventions disclosed in the present application will be explained as follows:

(1) An image display device includes plural pixels each having a current-drive type light emitting element, plural signal lines inputting image voltage to respective pixels and a pixel selection circuit for selecting pixels into which the image voltage is written through the plural signal lines from the plural pixels, in which the pixel selection circuit selects pixels in which voltage between terminals of the light emitting element is detected from the plural pixels during a detection period, and in which the signal line is also used as a detection line detecting voltage between terminals of the light emitting element.

(2) In (1), the pixel selection circuit has plural scanning lines, plural lighting control lines and plural detection gate lines, and each pixel has a drive transistor a first electrode of which is connected to a power source line, a switching transistor connected between a gate electrode and a second electrode of the drive transistor, a capacitor element connected between the gate electrode of the drive transistor and a corresponding signal line in the plural signal lines, a lighting transistor a second electrode of which is connected to the second electrode of the drive transistor and a first electrode of which is connected to one end of the light emitting element and a detection transistor a first electrode of which is connected to one end of the light emitting element and a second electrode of which is connected to a corresponding signal line in the signal lines, in which the other end of the light emitting element of each pixel is connected to a reference potential, in which a gate electrode of the switching transistor is connected to a corresponding scanning line in the plural scanning lines, in which a gate electrode of the lighting transistor is connected to a corresponding lighting control line in the plural lighting control lines and in which a gate electrode of the detection transistor is connected to a corresponding detection gate line in the plural detection gate lines.

(3) An image display device includes plural pixels each having a current-drive type light emitting element, plural signal lines inputting image voltage to respective pixels and a pixel selection circuit for selecting pixels into which the image voltage is written through the plural signal lines from the plural pixels, in which the pixel selection circuit has plural detection gate lines, in which each pixel has a drive transistor a first electrode of which is connected to a power source line and a second electrode of which is connected to one end of the light emitting element and a detection transistor a first electrode of which is connected to one end of the light emitting element and a second electrode of which is connected to a corresponding signal line in the signal lines, in which the other end of the light emitting element of each pixel is connected to a reference potential, in which a gate electrode of the detection transistor is connected to a corresponding detection gate line in the plural detection gate lines, and in which the detection transistor is turned on during a detection period.

(4) In (3), the pixel selection circuit has plural lighting control lines, and each pixel has a lighting transistor a second electrode of which is connected to the second electrode of the drive transistor and a first electrode of which is connected to one end of the light emitting element, in which a gate electrode of the lighting transistor is connected to a corresponding lighting control line in the plural lighting control lines, and in which the lighting transistor is turned off during a detection period.

(5) In (4), the pixel selection circuit has plural scanning lines, and each pixel has a switching transistor connected between a gate electrode and a second electrode of the drive transistor, a capacitor element connected between the gate electrode of the drive transistor and a corresponding signal line in the plural signal lines, in which a gate electrode of the switching transistor is connected to a corresponding scanning line in the plural scanning lines.

(6) An image display device includes plural pixels each having a current-drive type light emitting element, plural signal lines inputting image voltage to respective pixels, a signal line drive circuit supplying image voltage to the plural signal lines and a pixel selection circuit for selecting pixels into which the image voltage is written through the plural signal lines from the plural pixels, in which the signal line drive circuit has an image voltage generating circuit, a detection circuit and a switching circuit A connected to one end of each signal line, in which the switching circuit A supplies an image signal outputted from the image voltage generating circuit to each signal line during a writing period and inputting voltage between terminals of the light emitting element to the detection circuit during a detection period.

(7) in (6), a switching circuit B connected between the switching circuit A and one end of each signal line is included, in which the switching circuit B connects one end of each signal line to the switching circuit A during the writing period and the detection period and connects one end of each signal line to a ramp-wave voltage input line to which ramp-waveform voltage in which the voltage level varies with time is supplied.

(8) In (6) or (7), the detection circuit has plural constant power sources supplying constant current to respective signal lines and a voltage detection circuit provided by each signal line, detecting a voltage value generated at one end of each signal line when constant current is supplied to each signal line from each constant current source.

(9) In (8), the voltage detection circuit has an A/D converter converting a detected voltage value into a digital value, in which the image voltage generating circuit corrects normal image data inputted from the outside based on the digital value outputted from the A/D converter.

(10) In any one of (6) to (9), the pixel selection circuit has plural scanning lines, plural lighting control lines and plural detection gate lines, and each pixel has a drive transistor a first electrode of which is connected to a power source line, a switching transistor connected between a gate electrode and a second electrode of the drive transistor, a capacitor element connected between the gate electrode of the drive transistor and a corresponding signal line in the plural signal lines, a lighting transistor a second electrode of which is connected to the second electrode of the drive transistor and a first electrode of which is connected to one end of the light emitting element and a detection transistor a first electrode of which is connected to one end of the light emitting element and a second electrode of which is connected to a corresponding signal line in the signal lines, in which the other end of the light emitting element of each pixel is connected to a reference potential, in which a gate electrode of the switching transistor is connected to a corresponding scanning line in the plural scanning lines, in which a gate electrode of the lighting transistor is connected to a corresponding lighting control line in the plural lighting control lines and in which a gate electrode of the detection transistor is connected to a corresponding detection gate line in the plural detection gate lines.

(11) In (2), (5) or (10), each lighting transistor is turned on during a first period and a second period when lighting voltage is supplied to a corresponding lighting control line in the plural lighting control lines and is turned off during periods other than the above periods in a writing period, each switching transistor is turned on during the second period and a third period when reset voltage is supplied to a corresponding scanning line in the plural scanning lines and is turned off during periods other than the above periods in the writing period, each detection transistor is turned off during the writing period, each lighting transistor is turned on during a light emitting period continued from the writing period, each switching transistor is turned off during the light emitting period, each detection transistor is turned off during the light emitting period, each lighting transistor is turned off during a detection period, each switching transistor is turned off during the detection period, and each detection transistor is turned on during a period when detection voltage is supplied to a corresponding detection gate line in the plural detection gate lines and is turned off during periods other than the above period in the detection period.

(12) In any one of (1) to (11), the light emitting element is an organic light-emitting diode element.

### ADVANTAGE OF THE INVENTION

An advantage obtained by typical inventions in inventions disclosed in the present application will be explained as follows.

According to an image display device of the invention, it is possible to detect reduction of luminous efficiency of respective light emitting element arranged in a matrix state while suppressing increase of costs in the image display device.

### BRIEF DESCRIPTION OF THE DRAWINGS

FIG. 1 is a block diagram showing a schematic configuration of an organic EL display panel of an image display device according to an embodiment of the invention;

FIG. 2-1 is a circuit diagram for explaining a configuration of a pixel shown in FIG. 1;

FIG. 2-2 is a block diagram showing a schematic configuration of a signal-line drive circuit shown in FIG. 1;

FIG. 3 is a diagram showing voltage levels of a writing control line, a characteristic control line, and a lighting control line in a one-frame period of an image display device according to an embodiment of the invention;

FIG. 4 is a timing chart for explaining operations of a pixel of a k-th row in the organic EL display panel according to the embodiment of the invention in “writing period”;

FIG. 5 is a timing chart for explaining operations of the organic EL display panel according to the embodiment of the invention in “light-emitting period”;

FIG. 6 is a timing chart for explaining operations of a pixel of a k-th row in the organic EL display panel according to the embodiment of the invention in “detection period”;

FIG. 7 is a block diagram showing an example of an image voltage generating circuit shown in FIG. 2-2; and

FIG. 8 is a graph showing temporal variations of luminous efficiency (η_{EL}) and voltage between terminals (V_{EL}) of an organic EL element.

### DESCRIPTION OF THE PREFERRED EMBODIMENTS

Hereinafter, an embodiment of the invention will be explained in detail with reference to the drawings.

In all drawings for explaining the embodiment, same signs are put to components having the same functions, and repeated explanation thereof will be omitted.

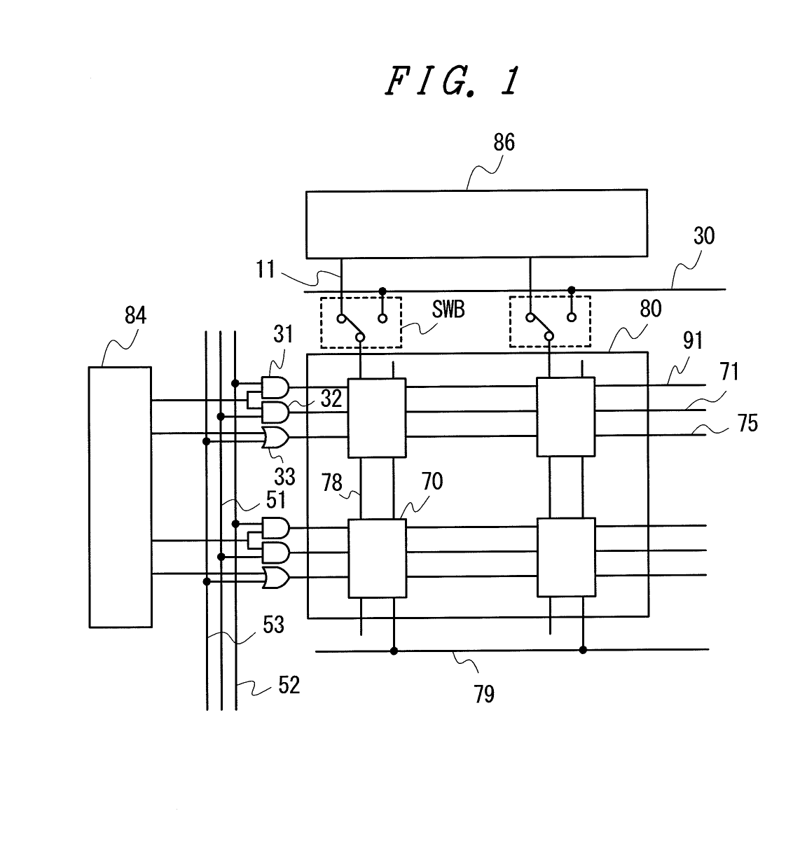

FIG. 1 is a block diagram showing a schematic configuration of an organic EL display panel of an image display device according to an embodiment of the invention.

As shown in FIG. 1, plural pixels 70 are provided in a matrix state in a display area 80 of an organic EL display panel. To the pixel 70, a signal line 78, a reset line (scanning line of the invention) 71, a lighting switch line 75, a detection gate line 91 and a power source line 79 are connected, respectively.

The reset line 71 is connected to an AND circuit 32, and scanning output of a scanning circuit 84 and voltage of a writing control line 51 are inputted to the AND circuit 32.

The detection gate line 91 is connected to an AND circuit 31, and scanning output of the scanning circuit 84 and voltage of a characteristic control line 52 are inputted to the AND circuit 31.

The lighting switch line 75 is connected to an OR circuit 33, and scanning output of the scanning circuit 84 and voltage of a lighting control line 53 are inputted to the OR circuit 33.

The configuration of the scanning circuit 84 is a shift register circuit which is commonly well-known, therefore, detailed explanation thereof is omitted here.

The signal line 78 is connected to a corresponding output terminal 11 of a signal line drive circuit 86 and a triangular-wave voltage line 30 through a switching circuit (SWB). The switching circuit (SWB) connects the signal line 78 to the corresponding output terminal 11 of the signal line drive circuit 86 during “writing period” and “detection period” which are described later, and connects the signal line 78 to the triangular-wave voltage line 30 during “light emitting period”.

The pixels 70 and respective circuits such as the scanning circuit 84 and the signal line drive circuit 86 are formed on a glass substrate by using a low-temperature polycrystalline silicon thin film which is commonly well known. Though a large number of pixels 70 are actually arranged in the display area 80 of the organic EL display panel, only four pixels are written in FIG. 1 for simplifying the drawing. As described later, common ground lines are also arranged to the pixels 70, however, these lines are not written.

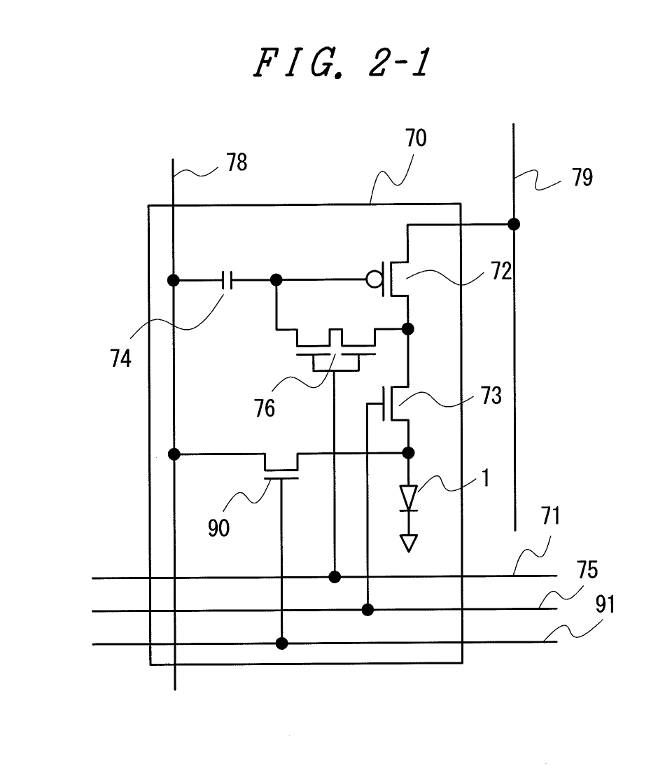

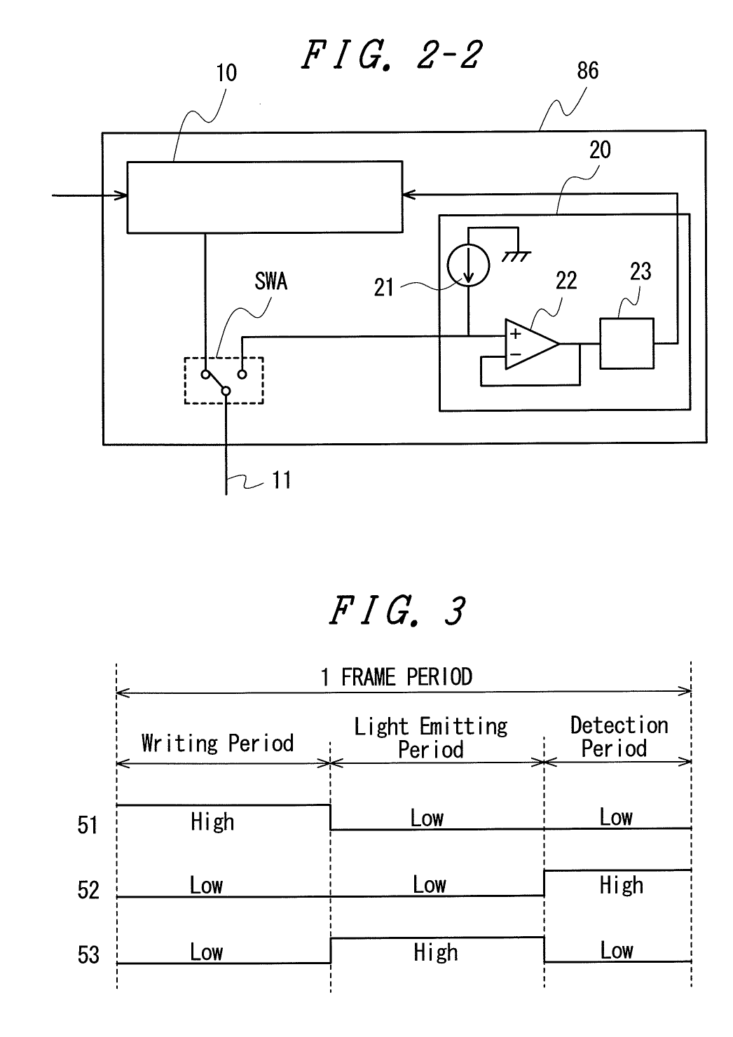

FIG. 2-1 is a circuit diagram for explaining a configuration of the pixel 70 shown in FIG. 1.

As shown in FIG. 2-1, an organic electroluminescent element (hereinafter, referred to as an organic EL element) 1 as a light-emitting element is provided to each of the pixel 70, a cathode electrode of the organic EL element 1 is connected to the common ground line. An anode electrode is connected to n-type thin-film transistor (hereinafter, referred to as a lighting TFT) for lighting 73 and the power source line 79 through a p-type thin-film transistor (hereinafter referred to as drive TFT) 72.

A gate electrode of the drive TFT 72 is connected to the signal line 78 through a storage capacitor (a capacitor element of the invention) 74, and a thin-film transistor for resetting (hereinafter, referred to as a reset switch) 76 is provided between a drain electrode and the gate electrode of the drive TFT 72. A gate electrode of the reset switch 76 is connected to the reset line 71. In addition, a gate electrode of the lighting TFT 73 is connected to the lighting switch line 75.

In the embodiment, a thin-film transistor for detecting voltage between terminals of the organic EL element 1 (hereinafter, referred to a detection TFT) 90 is connected between the anode electrode of the organic EL element 1 and the signal line 78, and a gate electrode of the detection TFT 90 is connected to the detection gate line 91.

The drive TFT 72, the lighting TFT 73, the reset switch 76 and the detection TFT 90 are formed on the glass substrate by using the polycrystalline silicon thin-film transistor in which polysilicon is used in a semiconductor layer respectively. A method of manufacturing the polycrystalline silicon thin film transistor or the organic EL element 1 is not largely different from a commonly announced method, therefore, explanation thereof is omitted here.

FIG. 2-2 is a block diagram showing a schematic configuration of the signal line drive circuit 86 shown in FIG. 1. As shown in the drawing, the signal line drive circuit 86 includes an image voltage generating circuit 10 and a detection circuit 20. The image voltage generating circuit 10 and the detection circuit 20 are connected to the corresponding output terminal 11 of the signal line drive circuit 86 through a switching circuit (SWA).

The detection circuit 20 includes a constant current source 21 and an A/D converter 23 taking voltage generated at one end of the signal line 78 out through a voltage circuit (so-called a buffer circuit) using an operational amplifier 22 and converting it to a digital value.

FIG. 7 is a block diagram showing a schematic configuration of an example of the image voltage generating circuit 10 shown in FIG. 2-2. The image voltage generating circuit 10 shown in FIG. 7 stores correction display data (Do) corresponding to display data (Di) to be inputted and correction data (Dr) outputted from the A/D converter 23 in a memory (for example, EPROM) 15, reading corresponding correction display data (Do) based on the inputted display data (Di) and correction data (Dr), and converting the correction display data (Do) into analog voltage in a D/A converter 16 to generate analog image voltage.

The switching circuit (SWA) connects the image voltage generating circuit 10 to the corresponding output terminal 11 of the signal line drive circuit 86 during “writing period” which is described later, and connects the detection circuit 20 to the corresponding output terminal 11 of the signal line drive circuit 86 during “detection period”.

The operation of the organic EL display panel according to the embodiment will be explained with reference to FIG. 3 to FIG. 6.

FIG. 3 is a diagram showing voltage levels on the writing control line 51, the characteristic control line 52, and the lighting control line 53 during one frame period.

In the embodiment, one frame period which is previously set to 1/60 seconds is divided into three, which are “writing period”, “light emitting period” and “detection period”. As the dividing ratio, for example, 70% is allocated to “writing period” and “light emitting period”, and 30% is allocated to “detection period”.

The lighting control line 53 is in a low level (hereinafter, L-level) during “writing period” and “detection period” and in a high level (hereinafter, H-level) during “light emitting period”, accordingly, H-level voltage is applied to the gate electrode of the lighting TFT 73 through the lighting switch line 75 during “light emitting period”, as a result, the lighting TFTs 73 of all pixels are turned on all at once.

The writing control line 51 is in the L-level during “light emitting period” and “detection period”, and in the H-level during “writing period”, accordingly, scanning output of the scanning circuit 84 is applied to the gate electrode of the reset switch 76 through the reset line 71 in “writing period”, as a result, the reset switches 76 of respective pixels 70 are sequentially turned on by each row (or by each display line).

Additionally, the characteristic control line 52 is in L-level during “writing period” and “light emitting period” and in H-level during “detection period”, accordingly, scanning output of the scanning circuit 84 is applied to the gate electrode of the detection TFT 90 through the detection gate line 91 during “detection period”, as a result, the detection TFTs 90 of respective pixels 70 are sequentially turned on by each row (or by each display line).

### [Writing Period]

In “writing period” of one frame, the scanning circuit 84 sequentially scans plural pixels of each row, and analog image voltage is written into signal lines 78 by the signal line drive circuit 86 through the switching circuit (SWA) and the switching circuit (SWB), being synchronized with the scanning.

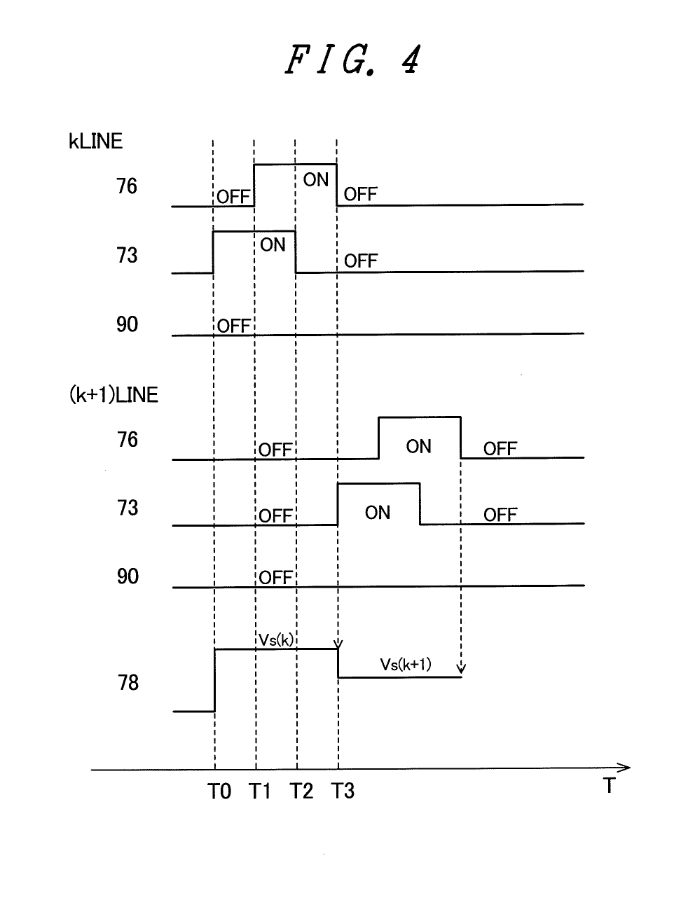

Here, the operation of the pixel 70 of the k-throw selected by the scanning circuit 84 during “writing period” will be explained with reference to FIG. 4.

FIG. 4 is a timing chart for explaining the operation of the pixel 70 of the k-th row in the organic EL display panel of the embodiment during “writing period”, representing operations of the reset switch 76, the lighting TFT 73 and the detection TFT 90 when the row of the pixel 70 is selected by the scanning circuit 84 and image voltage is written.

Driving-timing waveforms of the reset switch 76, the lighting TFT 73 and the detection TFT 90 are shown, in which a lower waveform represents OFF-state and an upper waveform represents ON-state.

During “writing period” of one frame, the writing control line 51 is in H-level, the characteristic control line 52 is in L-level and the lighting control line 53 is in L-level, therefore, the detection TFT 90 maintains OFF-state during “writing period”.

When image voltage is written into the pixel 70, the lighting TFT 73 is turned on at a time “T0”, next, the reset switch 76 is turned on at a time “T1”. Accordingly, the drive TFT 72 is in diode connection in which the gate electrode and the drain electrode are connected, and voltage of the gate electrode of the drive TFT 72 stored in the storage capacitor 74 in the previous field is cleared.

Next, when the lighting TFT 73 is turned off at a time “T2”, the drive TFT 72 and the organic EL element 1 are forcibly in a current-off state. At this time, since the gate electrode and the drain electrode of the drive TFT 72 are short-circuited by the reset switch 76, voltage of the gate electrode of the drive TFT 72 which is also one end of the storage capacitor 74 is automatically reset to voltage which is lower than voltage of the power source line 79 by a threshold voltage (Vth). At the other end of the storage capacitor 74, analog image voltage of Vs(k) is inputted from the signal line 78 at this time.

Next, the reset switch 76 is turned off at a time “T3”, the voltage difference between both ends of the storage capacitor 74 is stored in the storage capacitor 74 as it is. That is, when voltage equivalent to the analog image voltage of Vs(k) written in “writing period” is inputted to the storage capacitor 74 at the side of the signal line 78, voltage of the gate electrode of the drive TFT 72 is forcibly set to voltage lower than the voltage of the power source line 79 by the threshold voltage (Vth).

At this time, when the voltage value inputted to the storage capacitor 74 at the side of the signal line is higher than the analog image voltage of Vs(k), the drive TFT 72 is in OFF-state, and when the voltage value inputted to the storage capacitor 74 at the side of the signal line is lower than the analog image voltage of Vs(k), the drive TFT 72 is in ON-state. However, while scanning pixels of other rows, the lighting TFT 73 of the pixel is regularly in OFF-state, therefore, the organic EL element 1 does not turned on regardless of the level of the analog image voltage of the signal line 78.

The writing of the analog image voltage to the pixels is sequentially performed by each row as described above, and when the writing with respect to all pixels ends, “writing period” of one frame ends.

### [Light Emitting Period]

In “light emitting period” of one frame, the writing control line 51 is in L-level, the characteristic control line 52 is in L-level and the lighting control line 53 is in H-level, therefore, the detection TFT 90 maintains OFF-state during “light emitting period”.

The scanning circuit 84 is stopped and the lighting control line 53 is in H-level, therefore, H-level voltage is applied to the gate electrode of the lighting TFT 73 through the OR circuit 33 and the lighting switch line 75, accordingly, the lighting TFTs 73 of all pixels are turned on all at once.

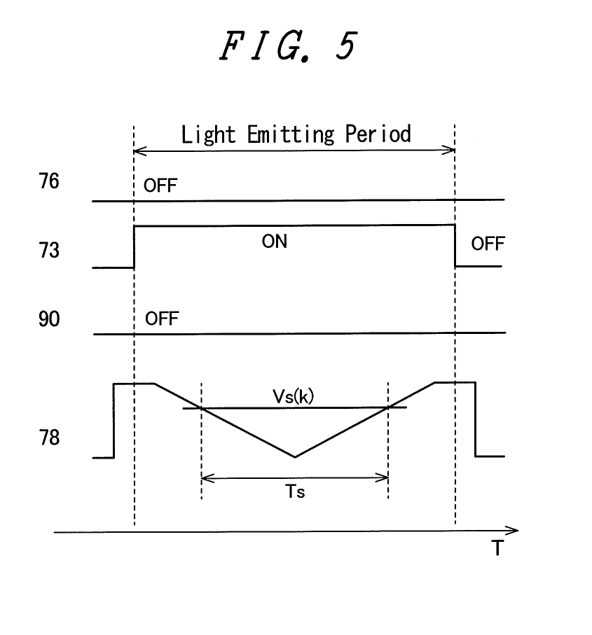

At this time, triangular-wave voltage shown in FIG. 5 is inputted from the triangular-wave voltage line 30 to the signal line 78 through the switching circuit (SWB). Note that FIG. 5 is a timing chart for explaining the operation of the organic EL display panel of the embodiment in “light emitting period”, representing operations of the reset switch 76, the lighting TFT 73 and the detection TFT 90.

As described above, each storage capacitor 74 is reset so that the drive TFT 72 is turned on or off according to whether the voltage of the signal line 78 is higher or lower than the analog image voltage of Vs(k) which has been previously written.

Since the lighting TFT 73 is regularly in ON-state in “light emitting period”, the organic EL element 1 of each pixel is driven by the drive TFT 72 according to voltage relation between the analog image voltage of Vs(k) which has been previously written and triangular-wave voltage applied to the signal line 78.

At this time, when mutual conductance (gm) of the drive TFT 72 is sufficiently high, it can be regarded that the organic EL element 1 is digitally driven, namely, lighting on/lighting off. That is, the organic EL element 1 is continuously lit with almost constant luminance during a period depending on the analog image voltage value of Vs(k) which has been previously written (period Ts in FIG. 5), and the modulation during the light emitting period is regarded as multiple-grey scale light emission visually.

This will be not fundamentally affected even when characteristics of drive TFT 72 fluctuate. It is preferable that the amplitude of triangular-wave voltage shown in FIG. 5 is allowed to correspond to signal amplitude of the analog image voltage.

In the embodiment, symmetrical triangular-wave voltage is applied so that barycenter on time axis in light emission does not depend on emission grey scale, however, it is possible to use unsymmetrical triangular-wave voltage, nonlinear triangular-wave voltage corresponding to gamma characteristic modulation or plural triangular-wave voltages instead of the above triangular-wave voltage, and it is also possible to obtain visual characteristics which are respectively different according to these voltages.

According to the embodiment, lighting time of the organic EL element 1 in one field is controlled to be only “light emitting period”, thereby providing non-light emitting period between adjacent two fields. Accordingly, in the embodiment, smooth display of moving pictures can be realized according to this. Also according to the embodiment, the light emitting period of the organic EL element 1 can be controlled without temporal fluctuations according to values of analog image voltage written into the storage capacitor 74 of each pixel to obtain grey scale display, therefore, fluctuations in display characteristics between pixels can be sufficiently reduced.

As each thin-film transistor, a single-channel thin-film transistor having simple configuration is used in the embodiment, however, for example, a CMOS-configured thin-film transistor can be applied.

In the embodiment, the peripheral drive circuit including the scanning circuit 84, the signal line drive circuit 86 and the like is formed by the low-temperature polycrystalline silicon (polysilicon) thin-film transistor circuit, however, the peripheral drive circuit or part of the circuit can be formed by a single-crystalline LSI (Large Scale Integrated circuit) circuit to be mounted. In that case, it is also preferable that the drive TFT 72, the lighting TFT 73, the reset switch 76 and the detection TFT 90 can be respectively formed on the glass substrate by using an amorphous silicon thin-film transistor in which amorphous silicon is used in a semiconductor layer.

### [Detection Period]

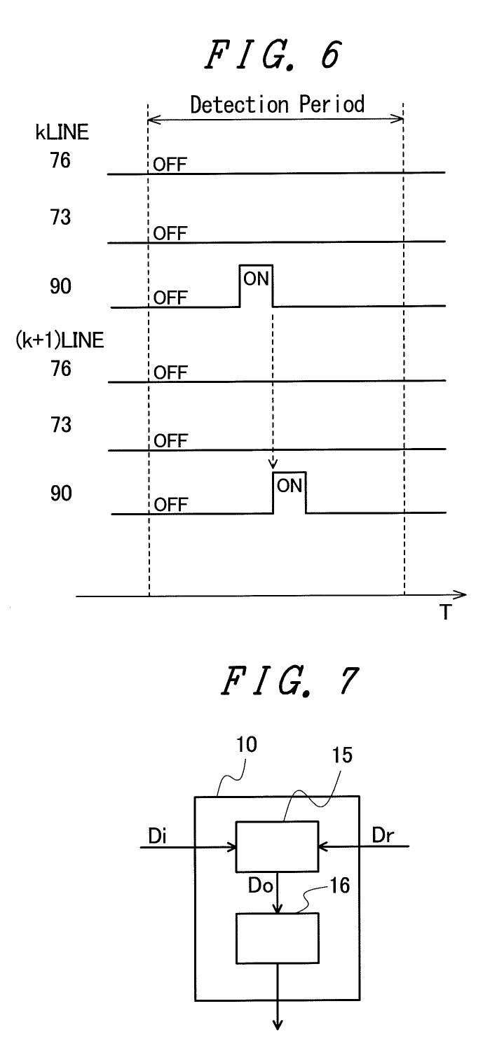

FIG. 6 is a timing chart for explaining the operation of the pixel 70 of k-th row in the organic EL display panel of the embodiment during “detection period”.

As shown in FIG. 6, in “detection period” of one frame, the scanning circuit 84 sequentially scans plural pixels of respective rows, and the detection TFTs 90 of respective pixels 90 of respective rows are sequentially turned on as well as the detection circuit 20 is connected to one end of the signal line 78 through the switching circuit (SWA) and the switching circuit (SWB).

According to this, constant current flows in the organic EL element 1 of each pixel 70 from the constant current source 21, and voltage (namely, voltage between terminals of the organic EL element 1) is generated at one end of the signal line 78.

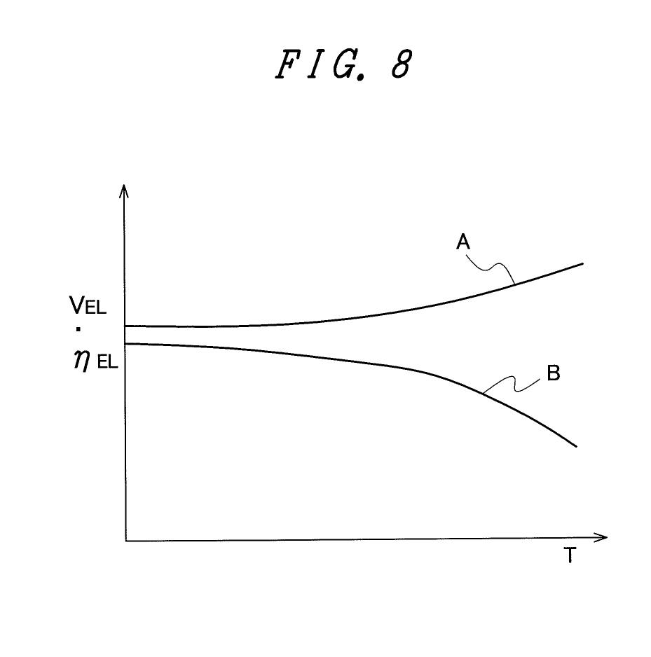

FIG. 8 is a graph showing temporal variations of luminous efficiency (η_{TEL}) and voltage between terminals (V_{EL}) of the organic EL element 1.

As shown by “B” in FIG. 8, the luminous efficiency (η_{TEL}) of the organic EL element 1 decreases with lapse of light emitting time (current-carrying time), and as shown by “A” in FIG. 8, voltage between terminals (V_{EL}) of the organic EL element 1 increases with the decrease of the luminous efficiency (η_{EL}).

In the embodiment, the voltage between terminals (V_{EL}) of the organic EL element 1 is detected by the detection circuit 20, and when the luminous efficiency (η_{EL}) is decreased, the signal line drive circuit 86 controls so as to increase the light-emitting luminance of the organic EL element 1. That is, when the voltage between terminals (V_{EL}) of the organic EL element 1 increases with the decrease of the luminous efficiency (η_{TEL}) as shown by “A” in FIG. 8, the signal line drive circuit 86 corrects image voltage so as to increase drive current (Id) of the organic EL element 1. Accordingly, the luminance of the organic EL element 1 is increased so as to compensate the decrease of the luminous efficiency (η_{TEL}).

As described above, according to the embodiment, it is possible that the detection circuit 20 detects voltage between terminals (V_{EL}) of the organic EL element 1 and that the signal line drive circuit 86 controls so as to increase the light-emitting luminance of the organic EL element 1 when the luminous efficiency (η_{EL}) decreases. Also, in the embodiment, the signal line 78 is used for writing of analog image voltage as well as for detecting voltage between terminals (V_{EL}) of the organic EL element 1, therefore, it is not necessary to provide a dummy pixel at an area outside the display area for detecting the decrease of luminous efficiency as in the image display device of related art.

Accordingly, in the embodiment, it is possible to detect the decrease of luminous efficiency of the organic EL element 1 without increasing costs. In addition, in the embodiment, it is possible to detect the decrease of luminous efficiency of respective organic EL elements 1 arranged in a matrix state.

In the embodiment, voltage between terminals (V_{EL}) of each pixel 70 is detected by one frame, however, luminous efficiency (η_{EL}) of the organic EL element 1 does not decrease rapidly with lapse of light emitting time (current-carrying time) as shown in FIG. 8, therefore, it is also preferable that the detection of voltage between terminals (V_{EL}) of the organic EL element 1 during the above “detection period” is executed when the power of the image display device of the embodiment is turned on. Also the embodiment can be used for compensating luminous efficiency (η_{EL}) of the organic EL element 1 due to temperature variations.

The invention made by the present inventors has been specifically described above based on the above embodiment, however, it goes without saying that the invention is not limited to the above embodiment and can be variously modified within a range not departing from the gist thereof.

What is claimed is:

1. An image display device, comprising:
plural pixels each having a current-drive type light emitting element;
plural signal lines inputting image voltage to respective pixels; and
a pixel selection circuit for selecting pixels into which the image voltage is written through the plural signal lines from the plural pixels,
wherein the pixel selection circuit selects pixels in which voltage between terminals of the light emitting element is detected from the plural pixels during a detection period, and
wherein the signal line is also used as a detection line detecting voltage between terminals of the light emitting element.

2. The image display device according to claim 1,
wherein the pixel selection circuit includes plural scanning lines, plural lighting control lines and plural detection gate lines,
wherein each pixel includes a drive transistor a first electrode of which is connected to a power source line, a switching transistor connected between a gate electrode and a second electrode of the drive transistor, a capacitor element connected between the gate electrode of the drive transistor and a corresponding signal line in the plural signal lines, a lighting transistor a second electrode of which is connected to the second electrode of the drive transistor and a first electrode of which is connected to one end of the light emitting element and a detection transistor a first electrode of which is connected to one end of the light emitting element and a second electrode of which is connected to a corresponding signal line in the signal lines,
wherein the other end of the light emitting element of each pixel is connected to a reference potential,
wherein a gate electrode of the switching transistor is connected to a corresponding scanning line in the plural scanning lines,
wherein a gate electrode of the lighting transistor is connected to a corresponding lighting control line in the plural lighting control lines and
wherein a gate electrode of the detection transistor is connected to a corresponding detection gate line in the plural detection gate lines.

3. An image display device, comprising:
plural pixels each having a current-drive type light emitting element;
plural signal lines inputting image voltage to respective pixels; and
a pixel selection circuit for selecting pixels into which the image voltage is written through the plural signal lines from the plural pixels,
wherein the pixel selection circuit includes plural detection gate lines,
wherein each pixel includes a drive transistor a first electrode of which is connected to a power source line and a second electrode of which is connected to one end of the light emitting element and a detection transistor a first electrode of which is connected to one end of the light emitting element and a second electrode of which is connected to a corresponding signal line in the signal lines,
wherein the other end of the light emitting element of each pixel is connected to a reference potential,
wherein a gate electrode of the detection transistor is connected to a corresponding detection gate line in the plural detection gate lines, and
wherein the detection transistor is turned on during a detection period.

4. The image display device according to claim 3,
wherein the pixel selection circuit includes plural lighting control lines,
wherein each pixel includes a lighting transistor a second electrode of which is connected to the second electrode of the drive transistor and a first electrode of which is connected to one end of the light emitting element,
wherein a gate electrode of the lighting transistor is connected to a corresponding lighting control line in the plural lighting control lines, and
wherein the lighting transistor is turned off during a detection period.

5. The image display device according to claim 4,
wherein the pixel selection circuit includes plural scanning lines,
wherein each pixel includes a switching transistor connected between a gate electrode and a second electrode of the drive transistor, a capacitor element connected between the gate electrode of the drive transistor and a corresponding signal line in the plural signal lines, and
wherein a gate electrode of the switching transistor is connected to a corresponding scanning line in the plural scanning lines.

6. An image display device, comprising:
plural pixels each having a current-drive type light emitting element;
plural signal lines inputting image voltage to respective pixels;
a signal line drive circuit supplying image voltage to the plural signal lines; and
a pixel selection circuit for selecting pixels into which the image voltage is written through the plural signal lines from the plural pixels,
wherein the signal line drive circuit includes an image voltage generating circuit, a detection circuit and a switching circuit A connected to one end of each signal line,
wherein the switching circuit A supplies an image signal outputted from the image voltage generating circuit to each signal line during a writing period and inputting voltage between terminals of the light emitting element to the detection circuit during a detection period.

7. The image display device according to claim 6, further comprising:
a switching circuit B connected between the switching circuit A and one end of each signal line,
wherein the switching circuit B connects one end of each signal line to the switching circuit A during the writing period and the detection period and connects one end of each signal line to a ramp-wave voltage input line to which ramp-waveform voltage in which the voltage level varies with time is supplied during a light emitting period continued from the writing period.

8. The image display device according to claim 7,
wherein the detection circuit includes plural constant power sources supplying constant current to respective signal lines and a voltage detection circuit provided by each signal line, detecting a voltage value generated at one end of each signal line when constant current is supplied to each signal line from each constant current source.

9. The image display device according to claim 8,
wherein the voltage detection circuit includes an A/D converter converting a detected voltage value into a digital value, and
wherein the image voltage generating circuit corrects normal image data inputted from the outside based on the digital value outputted from the A/D converter.

10. The image display device according to claim 9,
wherein the pixel selection circuit includes plural scanning lines, plural lighting control lines and plural detection gate lines,
wherein each pixel includes a drive transistor a first electrode of which is connected to a power source line, a switching transistor connected between a gate electrode and a second electrode of the drive transistor, a capacitor element connected between the gate electrode of the drive transistor and a corresponding signal line in the plural signal lines, a lighting transistor a second electrode of which is connected to the second electrode of the drive transistor and a first electrode of which is connected to one end of the light emitting element and a detection transistor a first electrode of which is connected to one end of the light emitting element and a second electrode of which is connected to a corresponding signal line in the signal lines,
wherein the other end of the light emitting element of each pixel is connected to a reference potential,
wherein a gate electrode of the switching transistor is connected to a corresponding scanning line in the plural scanning lines,
wherein a gate electrode of the lighting transistor is connected to a corresponding lighting control line in the plural lighting control lines and
wherein a gate electrode of the detection transistor is connected to a corresponding detection gate line in the plural detection gate lines.

11. The image display device according to claim 10,
wherein each lighting transistor is turned on during a first period and a second period when lighting voltage is supplied to a corresponding lighting control line in the plural lighting control lines and is turned off during periods other than the above periods in a writing period,
wherein each switching transistor is turned on during the second period and a third period when reset voltage is supplied to a corresponding scanning line in the plural scanning lines and is turned off during periods other than the above periods in the writing period,
wherein each detection transistor is turned off during the writing period,
wherein each lighting transistor is turned on during a light emitting period continued from the writing period,
wherein each switching transistor is turned off during the light emitting period,
wherein each detection transistor is turned off during the light emitting period,
wherein each lighting transistor is turned off during a detection period,
wherein each switching transistor is turned off during the detection period,
wherein each detection transistor is turned on during a period when detection voltage is supplied to a corresponding detection gate line in the plural detection gate lines and is turned off during periods other than the above period in the detection period.

12. The image display device according to claim 11,
wherein the light emitting element is an organic light-emitting diode element.
